(19) United States
(12) Patent Application Publication
(10) Pub. No.: US 2009/0109654 A1
(43) Pub. Date: Apr. 30, 2009

(54) BACKLIGHT SYSTEM WITH IR ABSORPTION PROPERTIES

(76) Inventors: Joerg Hinrich Fechner, Mainz (DE); Brigitte Hueber, Schwandorf (DE); Franz Ott, Konnersreuth (DE); Hrabanus Hack, Mainz (DE)

Correspondence Address: TAYLOR & AUST, P.C., P.O. Box 560, 142. S Main Street, Avilla, IN, 46710, US

(21) Appl. No.: 12/269,192

(22) Filed: Nov. 12, 2008

Related U.S. Application Data
(63) Continuation of application No. PCT/EP2007/004200, filed on May 11, 2007.

(30) Foreign Application Priority Data
May 16, 2006 (DE) DE102006023115.5

(51) Int. Cl. G09F 13/08; H01J 5/08

(52) U.S. Cl. 362/97.1; 313/112

(57) ABSTRACT

A backlight system for background illumination of displays or screens includes at least one light source with a glass envelope, whereby the glass composition of the glass envelope is doped with one or more doping oxides which absorb the IR-radiation, and/or whereby the glass envelope has an outside and/or inside coating which absorbs the IR-radiation, and/or whereby the backlight system has a coating on components other than the glass envelope, absorbing the IR-radiation.

### CROSS REFERENCE TO RELATED APPLICATIONS

This is a continuation of PCT application No. PCT/EP2007/004200, entitled “BACKLIGHT SYSTEM WITH IR ABSORPTION PROPERTIES”, filed May 11, 2007, which is incorporated herein by reference.

### BACKGROUND OF THE INVENTION

1. Field of the Invention

The invention relates to a backlight system with infrared (IR)-absorption properties.

2. Description of the Related Art

Simply described, a conventional system for back lighting of displays, especially flat displays, screens or similar equipment consists of one or a plurality of light-emitting components, such as several lights or lamps, as well as a unit which distributes the light evenly on the display or screen, a so-called light distribution unit. This light distribution unit may, for example be in the embodiment of a diffuser or a light guide, that is a light transporting plate or a so-called light guide plate (LGP).

For example, gas discharge lamps, especially miniaturized gas discharge lamps such as for example CCFL, EEFL or also panel lights such as FFL find an application in so-called backlight systems for background illumination of, for example flat screens. Gas discharge lamps contain inert gases for the purpose of light production, for example neon and argon (moreover also frequently mercury). The lamps also emit radiation in the infrared wave length range, for example in the range between 910-920 nm, caused by neon-/argon discharge, especially on ignition of the lamp.

Entertainment electronics devices today are almost always operable via an IR remote control. These remote controls often operate on wavelengths in the range between 850-950 nm. Through the emission of the gas discharge lamps within this wave length range malfunctioning of the devices may occur. In addition, the infrared (IR) radiation may heat up the backlight system, causing a heat buildup to occur.

What is needed in the art is to obviate this interfering IR-radiation or heating up of the backlight system. IR-coatings which, however, only have reflecting characteristics are already described in the current state of the art.

DE 102 13 036 A1 relates to a plastic film with an interference-multilayer system applied onto it, consisting of at least two layers which are obtained by hardening and/or heat treatment of a coating compound which contains nanoscalar inorganic solids particles with polymerizable and/or polycondensable organic surface groups by forming a cross-linked layer over the polymerizable and/or polycondensable organic surface groups. The films may be utilized as laminating films. “Nanoscalar inorganic solids particles” are understood to be medium particle diameters of not more than 200 nm, for example 5 to 10 nm. They may consist of any desired material, preferably metals and especially metallic compounds such as (possibly hydrated) oxides, sulfides, selenides and tellurides of metals and compounds of same. Especially preferred are nanoscalar particles of SiO2, TiO2, ZrO2, ZnO, Ta2O5, SnO2 and Al2O3 in all modifications as well as mixtures thereof, which are provided with polymerizable and/or polycondensable organic surface groups

U.S. Pat. No. 5,344,718 also describes various layer systems on a glass substrate which achieve acceptable low values of emissivity (“low-E”) and high IR-reflectivity. These layer systems utilize numerous layers of Si3N4 and nickel or nickel chromium between which one or more layers of IR-reflecting, metallic silver are arranged sandwich-style in a selected sequence.

In addition, EP 0 704 740 A2 relates to a HUD (head-up display) system in which an additional infrared filter is located preceding a light source.

What is further needed in the art is a backlight system for background illumination of screens or displays which avoids the disadvantages found in the current state of the art, and which does not create problems and malfunction of the devices caused through emission of the light sources, especially gas discharge lamps. In addition, a heat buildup in the backlight system should be prevented.

### SUMMARY OF THE INVENTION

The present invention provides a backlight system for background illumination of displays or screens, comprising at least one light source with a glass envelope,
whereby the glass composition of the glass envelope is doped with one or more doping oxides which absorb the IR-radiation, and/or
whereby the glass envelope has an outside and/or inside coating which absorbs the IR-radiation, and/or
whereby the backlight system has a coating on components other than the glass envelope, absorbing the IR-radiation.

Accordingly, the following inventive variations are feasible:
(1) a glass envelope with an IR-radiation absorbing doping;
(2) a glass envelope with an IR-radiation absorbing coating, whereby a glass envelope may be provided with an inside and/or outside coating;
(3) an IR-radiation absorbing coating on a component of the backlight system, other than the glass envelope;
(4) a glass envelope with an IR-radiation absorbing doping, whereby the glass envelope in addition also has an IR-radiation absorbing inside- and/or outside coating;
(5) a glass envelope with an IR-radiation absorbing doping and in addition an IR-radiation absorbing coating on at least one component of the backlight system, other than the glass envelope;
(6) a glass envelope with an IR-radiation absorbing inside and/or outside coating, together with an IR-radiation absorbing coating on at least one component of the backlight system, other than the glass envelope;

and
(7) a glass envelope with an IR-radiation absorbing coating that at the same time has an R-radiation absorbing inside and/or outside coating and in addition an IR-radiation absorbing coating on at least one component of the backlight system.

The present invention also provides the utilization of a glass envelope which is doped with one or more doping oxides which absorb the IR-radiation,

and/or
utilization of a glass envelope which has an inside and/or outside coating which absorbs the IR-radiation,
and/or
utilization of a coating which absorbs the IR-radiation on components of a backlight system, other than the glass envelope,
for absorption of IR-radiation in a backlight system.

Therefore, the following inventive variations are feasible also in this case:
(1) Utilization of a glass envelope with an IR-radiation absorbing doping;
(2) Utilization of a glass envelope with an IR-absorbing coating, whereby the glass envelope may have an inside and/or outside coating;
(3) Utilization of an IR-absorbing coating on a component of the backlight system, other than the glass envelope;
(4) Utilization of a glass envelope with an IR-radiation absorbing doping, whereby the glass envelope at the same time also has an IR-radiation absorbing inside and/or outside coating;
(5) Utilization of a glass envelope with an IR-radiation absorbing doping and in addition with an IR-radiation absorbing coating on at least one component of the backlight system, other than the glass envelope;
(6) Utilization of a glass envelope with an IR-radiation absorbing outside coating, together with an IR-radiation absorbing coating on at least one component of the backlight system, other than the glass envelope;

and
(7) Utilization of a glass envelope with an IR-radiation absorbing coating which at the same time also has an IR-radiation absorbing inside and/or outside coating and in addition also an IR-radiation absorbing coating on at least one component of the backlight system,
   whereby each of the inventive variations serves to absorb undesired IR-radiation in a backlight system.

Accordingly, a plurality of solutions for the protection of backlight systems from undesired IR-radiation can be provided.

This may for example be achieved by doping the glass envelope of the light source, for example a gas discharge lamp, with one or more doping oxides which absorb the IR-radiation. These are for example ytterbium-oxide, dysprosium-oxide, samarium-oxide, iron(II)oxide and copper(II)oxide, as well as compounds of these. The doping with ytterbium-oxide is more especially preferred.

The sum of Yb₂O₃, Sm₂O₃, Dy₂O₃, FeO and CuO amounts especially preferably to 0.3-50 weight-%.

The glass envelope contains more especially preferred the following doping oxides in the following ranges:

| | | |
|---|---|---|
| Yb₂O₃ | 0-40 | weight-% |
| Sm₂O₃ | 0-40 | weight-% |
| Dy₂O₃ | 0-40 | weight-% |
| FeO | 0-10 | weigh % |
| CuO | 0-10 | weight-% |

whereby the sum of Yb2O3, Sm2O3, Dy2O3, FeO and CuO is 0.3-50 weight-%.

It is to be noted that FeO [Fe(2+)] should be used for IR-blocking only if the glass does not contain TiO₂, in other words does not posses UV-blocking with TiO₂. Otherwise there is a danger of discoloration of the glass. When doping with Fe(2+) there is a general tendency that a green-coloration of the glass could occur, so that preferably the smallest possible amounts are used.

According to an additional inventive embodiment variation an outside and/or inside coating of the light source glass, such as that of a gas discharge lamp, may be provided in addition or as an alternative.

According to yet an additional embodiment variation, other components of the backlight system, for example the light distributing unit (light guide plate, LGP), especially the diffuser plate, the support plate or disk, the cover or protective plate, (partial) surfaces or sections of the backlight system, or components thereof can be provided in addition, or alternatively with an IR-absorbing layer. The IR-absorbing layer can also act reflectively for IR-radiation. The IR-absorbing layer is especially preferably composed of several SiO₂ and TiO₂ layers. These may for example be 10, 20 or more different layers. Ta₂O₅ is also suitable in place of TiO₂. In this case the coating consists preferably of a multi-layer interference system of high- and low-refractive layers, preferably of low refractive SiO₂ and high refractive TiO₂ or Ta₂O₅ layers. Also suitable would be interference layer systems which would include Ta₂O₅-layers or Nb₂O₅-layers or Y₂O₃-layers or ZrO₂-layers instead of TiO₂ layers.

In addition to the outside or inside coating of the glass of the gas discharge lamp, other components of the backlight system, such as the diffuser plate or the light guide plate, the so-called light guide plate or light transporting plate may also be coated.

Alternatively to the aforementioned coatings, conductive oxidic layers, for example In₂O₃, SnO₂, ZnO or conductive oxidic layers, for example consisting of In₂O₃, SnO₂, ZnO which are doped with suitable elements such as Sn, F in order to increase the conductivity or the reflection can also be used.

Other possible types of coating are thin metallic layers of for example silver or a suitable silver-based layer system.

These inventive layers or coatings can be applied according to different methods. For example a dip method, as described in EP 0 305 135, or the Chemical Vapor deposition (CVD)-method, described in EP 0369 253 is feasible. A PVD-method according to EP 0 409 451 can also be utilized. Especially advantageous however is the utilization of the so-called PICVD-method (plasma-impulse-CVD-method) according to DE 198 52 454 A1, whereby the coating is carried out in a microwave reactor by way of a microwave plasma CVD-method. By having made reference, the disclosure content of this documentation is incorporated into the present disclosure in its entirety.

As described, the discussed alternatives can also be combined according to the current invention.

In accordance with the current invention a so-called “all in one” solution is therefore provided, whereby additional expensive components, such as filters can be dispensed with. In accordance with the current invention one IR-radiation absorbing layer is provided on the lamp, and/or the glass envelope of the light source itself offers protection against IR-radiation through its selected glass composition. Heating up of the lamp and heating up of the entire backlight system can hereby be avoided. A heat build-up caused by undesirable IR-rays is hereby totally eliminated in accordance with the current invention. The durability of the lamp and the additional components which are part of the backlight system is clearly increased, since the temperature load can be clearly reduced. In addition, IR-interference radiation which could impair the operation of the backlight system is obviated.

In addition it is much more practicable and cost effective if separate IR-radiation filters can be omitted and if the IR-radiation protection is actually part of the lamp and/or the backlight system. In addition to a simplified handling due to the integrated IR-radiation protection and the omission of additional components, especially cost effective materials, particularly synthetic materials can be utilized in the backlight system, since henceforth lower requirements are placed upon the temperature protection of the utilized synthetic materials. The produced heat is preferably removed directly through the light source. In other words through the coating of the lamp which absorbs IR-radiation, and/or the glass composition of the glass envelope of the light source which is doped with one or a plurality of doping oxides which absorb the IR-radiation, and/or another component of the backlight system possesses a coating which absorbs the IR-radiation.

In accordance with an especially preferred embodiment of the invention the backlight system for background illumination of displays or screens includes at least one light source with a glass envelope, as well as a synthetic light distribution unit (light guide plate, LGP). In this embodiment an especially cost effective synthetic material can be utilized which needs to withstand clearly lower temperatures, since the described protection against IR-rays is provided in the backlight system.

Any light source known by the expert as being suitable for this purpose can be used as the inventively utilized light source. For example a discharge lamp such as a low pressure discharge lamp, especially a fluorescent lamp, more especially preferred a miniaturized fluorescent lamp.

A backlight lamp of this type can be manufactured preferably from a drawn tubular glass. The light source can be arranged to have a mid-section which is preferably largely transparent and which represents the glass envelope in the form of a hollow body with an inside and outside, as well as two ends which can be equipped with the appropriate connections by furnishing metal or metal alloy wires. It is feasible to fuse the metal or metal wires with the glass envelope of the glass body in a tempering process. The metal or metal alloy wires are electrode lead-throughs and/or electrodes.

These lead-throughs are preferably tungsten or molybdenum metals or Kovar alloys. The thermal longitudinal expansion (CTE) of the previously cited glass composition of the glass envelope preferably coincides largely with the longitudinal expansion (CTE) of the previously cited lead-throughs so that no tensions, or only defined and purposefully selected tensions occur in the area of the lead-throughs.

Besides the light emitting unit, a light distributing unit is generally present in the inventive system. Within the scope of the invention this is not particularly limited. According to an especially preferred embodiment the light distribution unit is however constructed of synthetic material. A diffuser or a diffuser plate or disk, or a light transmitting or transporting plate or disk such as an LGP (light guiding plate) may for example also be utilized.

The synthetic material for the light distribution unit is especially preferably selected from the group consisting of polyvinyl chloride (PVC), polystyrene (PS), polyethylene (PE), polypropylene (PP), polyamides (PA), polycarbonates (PC), polyimides, polyetherketones (PEK, PEEK, PAEK), Polyphenylene sulfide (PPS), SAN (styrene-acrylonitrile-copolymers), polybutyleneterephthalates (PBT), polymethylmethacrylates (PMMA), polycarbonates and polymers on cyclo-olefin base. Polymethylmethacrylates (PMMA) as well as polymers on cyclo-olefin base and their mixtures are preferred.

Inventively the structure of the backlight arrangement, as well as the structure and the arrangement of the light source and light distribution unit are not especially limited. Several inventive variations are described below, however the inventive theory should not to be limited to these.

The inventive backlight system generally includes an especially reflective base- or support plate, as well as a cover- or substrate plate in whose immediate surrounding one or more light sources are located. Especially miniaturized backlight lamp arrangements which are preferred according to the invention are utilized.

Therefore, preferably one or a plurality of individual, especially miniaturized light sources is used. Several, especially at least two light sources can be positioned preferably parallel to each other and may be positioned for example, between a support plate and a cover plate. The light sources may be provided for example in one or several recesses of the support plate, whereby one recess always contains one light source. The substrate or cover plate, or disk can be any desired plate or disk that is conventionally used for this purpose and which, depending upon the system design and planned application, functions as a light distribution unit, or merely as a cover. The substrate or cover plate or disk can therefore be, for example an opaque diffuser plate or a clear transparent disk. The light distribution unit is preferably constructed of synthetic material.

In another backlight system of this type synthetic materials can be used which—in contrast to the current state of the art—meet the clearly lower requirements of temperature stability.

In accordance with the current invention the glass envelope of the light source can be doped with one or several doping oxides in order to absorb the undesired IR-radiation. Alternatively an IR-absorbing coating may for example be provided on the support or cover plate, or as an outside coating on the glass envelope. An inside coating of the envelope glass would also be feasible. The inventive variations may of course also be combined.

This arrangement is preferred for larger displays, for example televisions.

Alternatively the light sources such as for example fluorescent lamps may be equipped with external or internal electrodes. This depends on the selected arrangement.

In accordance with an additional inventive embodiment the light source according to the inventive backlight system may for example be located outside the light distributing unit. Therefore, the light source or light sources may for example be located on the outside of a display or screen, whereby the light is then advantageously released uniformly across the display or screen by way of a light transporting plate functioning as a so-called LGP (light guide plate). Such light guide plates are preferably manufactured of synthetic material, as previously described and posses for example a rough surface over which light is released. An appropriate IR-radiation absorbing glass can be provided as a glass envelope for the light source, and/or an IR-absorbing outside coating and/or inside coating on the glass envelope and/or an IR-absorbing coating on one or more components of the backlight system, such as a light guide plate, may be applied.

A lamp system without electrodes, in other words a so-called EEFL-system (external electrode fluorescent lamp) can also be utilized in the inventive backlight system.

In a preferred embodiment of this inventive variation of the invention, the light producing unit includes for example an enclosed space which is defined at the top by a preferably structured plate, below by a support plate, as well as by walls on the sides. The light sources, such as fluorescent lamps are located for example at the sides of the unit. This enclosed space may for example be sub-divided further into radiation spaces which may contain a luminous discharge substance which is applied, for example to a predetermined thickness onto a support plate. An opaque diffuser plate or a clear transparent plate may again be used for the cover plate or disk, depending upon system configuration. For absorption of the IR-radiation the glass envelope of the EEFL lamp may be doped with an appropriate amount of doping oxides and/or components of the backlight arrangement and/or the glass envelope itself can be provided with an IR-absorbing coating.

An inventive backlight system according to this variation is for example a gas discharge lamp without electrodes. In other words, there are no lead-throughs, only externally located electrodes.

In principle however, internal bonding is also possible. In this instance an ignition of the plasma can occur via internal electrodes.

This type of ignition represents an alternative technology. Such systems are described as CCFL-systems (cold-cathode fluorescent lamp). The electrode lead-throughs may specifically include tungsten and molybdenum metal as a lead-through material, or also Kovar alloy. The arrangements previously described form a large flat backlight and are therefore also referred to as flat-backlight.

The glass envelope of the light source contains a glass composition, or consists of same, whereby the type of glass that is especially preferred for use in the inventively utilized light sources are borosilicate glasses. Borosilicate glasses include SiO₂ as well as B₂O₃ as first components, and alkali and/or alkaline earth oxide, for example Li₂O, Na₂O, K₂O, CaO, MgO, SrO and BaO as additional components.

Borosilicate glasses having a content of B₂O₃ between 5 and 15 weight-% demonstrate a high chemical stability. Furthermore, borosilicate glasses of this type can also be adapted in the thermal elongation (so-called CTE) to metals, for example tungsten or metal alloys such as KOVAR, by selecting the composition ranges. This avoids tensions in the area of the lead-throughs.

Borosilicate glasses having a content of B₂O₃ between 15 and 25 weight-% possess excellent processing capabilities, as well as good adaptability of the thermal elongation (CTE) to the metal (tungsten) and the alloy KOVAR (Fe—Co—Ni-alloy).

Borosilicate glasses having a B₂O₃ content in the range of 25-35 weight-% are especially advantageous for utilization in gas discharge lamps without electrodes that is, lamps whose electrodes are located outside the lamp bulb.

In a first embodiment of the invention the base glass normally contains preferably at least 50 weight-% or at least 55 weight-% SiO₂, whereby at least 60 weight-% and preferably at least 63 weight-% are especially preferred. An especially preferred minimum amount of SiO₂ is 65 weight-%. However, in individual cases a minimum content of 35 weight-% SiO2 is also feasible. The maximum amount of SiO₂ is 85 weight-%, especially 83 weight-%, whereby 79 weight-% and especially a maximum of 75 weight % are more especially preferred. According to the invention B₂O₃ is contained in an amount of more than 0 weight %, preferably more than 3 weight-%, advantageously more than 5 weight-% and especially at least 10 weight-%, whereby at least 15 weight-% are especially preferred. The maximum amount of B₂O₃ is 35 weight-% maximum, preferably however 32 weight-% maximum, whereby a maximum of 30 weight-% is especially preferred.

Even though the glass composition of the glass envelope can, in individual cases, also be free of Al₂O₃, it normally contains Al₂O₃ in a minimum amount of 0.1, especially 0.2 weight-%. Al₂O₃ is normally contained in an amount of 0-25 weight-%, preferably 0-20 weight %, more preferably 0-10 weight-%, whereby a minimum amount of 0.5 weight-% or 1 weight-% and especially 2 weight-% is preferred. The maximum amount is normally 25 weight-%, preferably 10 weight-%.

The sum of alkali oxides is preferably <5 weight-%, preferably <1 weight-%. The glass composition is especially preferred free of alkali, with the exception of unavoidable impurities. Li₂O is utilized preferably in an amount of 0-5, especially <1.0 weight-%, Na2O preferably in an amount of 0-10, especially <3.0 weight-%, and K2O preferably in an amount of 0-9, especially <5.0 weight-%, whereby a minimum amount of ≦0.1 weight-%, or ≦0.2 and especially ≦0.5 weight-% respectively is preferred.

According to the current invention alkaline earth oxides such as Mg, Ca, and Sr respectively are contained on an amount of 0-20 weight-%, and especially in an amount of 0-8 weight-% or 0-5 weight-%. BaO may preferably be present in an amount of 0 to 64 weight-%.

According to the current invention the sum of the alkaline earth oxides amounts to 0-64 weight-%, especially 0-50 weight-%, preferably 0-40 weight-%.

In order to achieve as low a power loss Ploss as possible and therefore a high level of efficiency of the utilized light source, especially in the case of gas discharge lamps with the electrodes located on the outside, it has proven to be especially advantageous if the quotient from the loss angle tan δ and the relative permittivity ∈′ is relatively low. This results from the equation:

$${P}_{loss} \approx 2 \cdot \frac{1}{ω} \cdot \frac{tan δ}{{ɛ}^{′}} \cdot \frac{d}{A} \cdot {I}^{2}$$

whereby
ω: Radian frequency
tan δ: Loss angle
∈′ Relative permittivity
d: Thickness of capacitor (here thickness of glass)
A: Electrode surface
I: Intensity of current

When using for EEFL, this quotient is preferably <5×10⁻⁴ and <4×10⁻⁴, especially preferably <3×10⁻⁴ and <2.5×10⁻⁴, more especially preferably <2×10⁻⁴ and <1×10⁻⁴.

In order to set the quotient of tan δ and ∈′ as low as possible according to the current invention, the glass composition contains, for example highly polarizable elements in oxidic form, integrated into the glass matrix. Such highly polarizable elements in oxidic form may be selected from the group consisting of the oxides of Ba, Cs, Hf, Ta, W, Re, Os, Ir, Pt, Pb, Bi, La, Ce, Pr, Nd, Eu, Gd, Tb, Ho, Er, Tm, and/or Lu.

Preferably at least one of these oxides is contained in the glass composition. Mixtures of two or more of these oxides are also feasible. Therefore at least one of these oxides is preferably contained in an amount of >0 to 64 weight-%, preferably 5 to 60, especially preferably 10 to 50 weight-%, especially 15 to 55 weight-%. Even more preferable are 20 to 45 weight-%, especially 20 to 40 weight-%. Especially advantageous is if they do not fall short of 15, especially 18, and preferably 20 weight-% are not gone below.

It is especially preferred if Cs₂O, BaO, PbO, Bi₂O₃, as well as the rare earth metal oxides lanthanum oxide, gadolinium oxide, ytterbium oxide are contained in the glass composition according to the invention.

Especially preferred are contents of at least 15 weight-%, even more preferable is 18 weight-%, especially 20 weight-%, and more especially preferred more than 25 weight-% of one or more of the highly polarizable elements in oxide form in the glass composition.

The CeO₂ content in the glass envelope is preferred at 0-10 weight-%, whereby amounts of 0-5 and especially 0-1 weight-% or 0-0.5 weight-% are preferred. The Nd₂O₃ content is preferably 0-5 weight-%, whereby amounts of 0-2, especially 0-1 weight-% are especially preferred. The Bi₂O₃ content is especially preferred at 0-64 weight-%, preferably from 5-60, especially preferably 10 to 55 weight-%, particularly 15 to 50 weight-%. Also preferred are 20 to 55 weight-% or 20 to 50 weight-%. Even more preferable are 20 to 45 weight-%, especially 20 to 40 weight-% or 20 to 35 weight-%.

In accordance with the current invention the sum of all earth alkali oxides then amounts to preferably 0-64 weight-%, especially 5-60, preferably 10-55 weight-%, especially preferably 20-55 weight-%. Also preferred are 20-40 weight-%.

The glass can be free of ZnO, does however contain preferably a minimum amount of 0.1 weight-% and a maximum amount of 30 weight-%, whereby maximum contents of 20 weight-%, preferably 10 weight-%, especially 3 weight-% can still be entirely appropriate. ZrO2 is contained in an amount of 0-5 weight-%, especially 0-3 weight-%, whereby a maximum content of 3 weight-% has been sufficient in many cases. In addition, WO₃ and MoO₃ can, independently from each other be contained in an amount of 0-5 weight-% or 0-3 weight-% respectively, especially however 0.1-3 weight-%.

Inventively, it has proven to be especially advantageous if the sum Al₂O₃+B₂O₃+Cs₂O+BaO+Bi₂O+PbO is in the range of 15 to 64 weight-%, preferably 15 to 64 weight-%, especially 20 to 60 weight-%. Since the maximum amount of B₂O₃ used is normally 35 weight-%, the remaining 45 weight-% are distributed over one or several of the polarizable oxides BaO, Bi₂O₃, Cs₂O and PbO.

In accordance with a preferred embodiment the PbO content is advantageously adjusted to 0 to 64 weight-%, preferably 10-60 weight-%, more preferably 15-55 weight-%. More especially preferred are 20 to 50 weight-%.

For the purpose of adjusting the “UV edge” (absorption of UV-radiation) the glasses may also contain TiO₂, even though they may basically also be free of it. The maximum TiO₂ content is preferably 10 weight-%, especially a maximum of 8 weight-%, whereby a maximum of 5 weight-% is preferred. A preferred minimum content of TiO₂ is 1 weight-%. Preferably a content of at least 80% to 99%, especially 99.9 or 99.99% of the contained TiO₂ are present in the form of Ti⁴⁺. In some instances Ti⁴⁺ contents of 99.999% have proven to be significant, whereby the melted mass is produced preferably under oxidative conditions. Oxidative conditions are to be understood especially to be conditions where titan is present in the previously cited amounts in the form of Ti⁴⁺ or where oxidation occurs to this level. These oxidative conditions can be easily achieved in the melted glass, for example through addition of nitrates, especially alkali nitrates and/or alkali earth nitrates. An oxidative melted mass can also be achieved by blowing oxygen and/or dry air into it. It is also possible to produce an oxidative melted mass by way of an oxidizing burner adjustment, for example through melting of the glass batch.

If the TiO₂ contents of the glass composition are >2 weight-% and a glass mixture batch having a total Fe₂O₃ content of >5 ppm is used, then it is preferable to use As₂O₃ for refining and nitrate for melting. The addition of nitrate would preferably be in the form of alkali nitrate at contents of >1 weight-%, in order to suppress coloring of the glass in the visible range (the formation of the llmenite (FeTiO₃)-mixed oxides). In addition, refining with Sb₂O₃ and nitrate is also feasible.

Even though nitrate, preferably in the form of alkali and/or alkali earth nitrate is added to the glass during the melting process, the nitrate concentration in the finished glass after refining amounts to a maximum of only 0.01 weight-%, and in many instances to 0.001 weight-% at most.

The Fe₂O₃ content is preferably 0-5 weight-%, whereby amounts of 0-1 and especially 0-0.5 weight-% are preferred. The MnO2 content is preferably 0-5 weight-%, whereby amounts of 0-2, especially 0-1 weight-% are even more preferred. The MoO₃ component is more preferred in an amount of 0-5 weight-%, preferably 0-4 weight-%.

Fe₂O₃ can be added to the glass in an amount of up to 5 weight-%. However, the contents are preferably clearly lower. If there is an iron content then this is converted into its oxidation number 3⁺ through the oxidizing conditions during melting, for example through use of nitrate-containing raw materials, thereby minimizing the discoloration in the visible wave length range. The Fe₂O₃ content in the glass is preferably <500 ppm. Generally Fe₂O₃ is present in the form of impurities.

Especially when adding of TiO₂ in volumes of >1 weight-% a discoloration of the glasses in the visible wave length range can be avoided at least partially especially in that the melted glass is essentially chloride-free, and that specifically no chloride and/or Sb₂O₃ is added for refining during the glass melting process. It had been found that a blue coloration of the glass—as occurs especially when TiO₂ is used—can be avoided when chloride is not used as a refining agent. According to the invention, the maximum content of chloride as well as fluoride is 2, especially 1 weight-%, whereby a content of 0.1 weight-% max. is preferred.

It has further been demonstrated that sulfates, such as are used for example as refining agents, like the previously referred to substances also lead to a discoloration in the visible wave length range in the glass. It is therefore preferable if the use of sulfates is also avoided. According to the current invention the maximum sulfate content is 2 weight-%, especially 1 weight-%, whereby contents of 0.1 weight-% are preferred. A wavelength range between 320 nm and 780 nm are to be understood to be a visible wave length range according to the current invention.

In addition it has been found that the previously described disadvantages relating to the glass can be further avoided if refining takes place under oxidizing conditions with As₂O₃. The glass would preferably contain 0.01-1 weight-% As₂O₃.

It has been shown that, even though the glasses are very stable against solarization during UV radiation, the solarization stability may be enhanced even further through low contents of PdO, PtO₃, PtO₂, PtO, RhO₂, Rh₂O₃, IrO₂ and/or Ir₂O₃. The normal maximum content of such substances is normally max. 0.1 weight-%, preferably a maximum of 0.01 weight-%, whereby a maximum of 0.001 weight-% is especially preferred. The minimum content for these purposes is normally 0.01 ppm, whereby at least 0.05 ppm and especially at least 0.1 ppm is preferred.

The second embodiment of a suitable glass envelope for a light source in the inventive backlight system has a minimum content of SiO₂ of 60 weight-%, preferably at least 62 weight-%, whereby a minimum content of 64 weight-% is especially preferred. The maximum content of SiO2 in the inventive glass is at most 85 weight-%, especially 79 weight-%, whereby a content of 75 weight-% maximum is preferred. An especially preferred maximum content is 72 weight-%. Glass types having a very high SiO₂ content distinguish themselves through a low dielectric dissipation factor tan δ and are therefore especially suitable for fluorescent lamps without electrodes.

The B₂O₃ content is 15 weight-% maximum, especially 10 weight-% maximum, whereby a content of 5 weight-% maximum is preferred. A maximum content of B₂O₃ of 3 weight % at most is especially preferred, whereby a maximum content of 2 weight-% is more especially preferred. In individual cases, the inventive glass may also be completely free of B₂O₃. However, in a preferred embodiment it would contain at least 0.1 weight-%, whereby 0.5 weight-% is preferred. Especially preferred is a minimum content of 0.75 weight-%, whereby 0.9 weight-% is more especially preferred.

Even though the glass may—in accordance with the second embodiment—be Al₂O₃ free in some individual instances, it does however normally contain at least 0.1, especially 0.2 weight-% Al₂O₃. A minimum amount of 0.3 is preferred, whereby minimum amounts of 0.7, especially at least 1.0 weight-% are preferred. The highest Al₂O₃ content is normally 10 weight-%, whereby a maximum of 8 weight-% is preferred. In many instances a maximum amount of 5 weight-%, especially 4 weight-% has proven sufficient.

The glass according to the second embodiment contains alkali and alkaline earth oxides. The total alkaline oxide content amounts to at least 5 weight-%, especially at least 6 weight-%, preferably however at least 8 weight-%, whereby a minimum total amount of at least 10 weight-% alkaline oxides is especially preferred. The maximum content of all alkaline oxides amounts to 25 weight-% at most, whereby a maximum of 22 weight-% and especially 20 weight-% is especially preferred. In many instances a maximum amount of 18 weight-% has been sufficient. The Li₂O content, according to the invention is 0 weight-% to 10 weight-% at most, whereby a maximum amount of 8 weight-% and especially a maximum of 6 weight-% is preferable. K₂O is contained in an amount of at least 0 weight-% and at most 20 weight-%, whereby a minimum content of 0.01 weight-%, preferably 0.05 weight-% is preferred. In individual instances a minimum content of 1.0 weight-% has proven to be suitable. In a preferred embodiment the maximum K₂O content is 20 weight-%, whereby a maximum of 15 and especially a maximum of 10 weight-% is preferred. In many instances a maximum content of 5 weight-% has been completely sufficient.

In individual instances the Na₂O content is 0 weight-% and a maximum of 20 weight-%. However, the Na₂O content is preferably at least 3 weight-%, especially at least 5 weight-%, whereby contents of at least 8 weight-% and especially at least 10 weight-% are preferred. In particularly preferred embodiments and according to the current invention, sodium oxide is present in an amount of at least 12 weight-%. Preferred maximum amounts of Na₂O are 18 weight-% or 16 weight-%, whereby an upper limit of 15 weight-% is especially preferred.

The content of individual alkaline earth oxides is a maximum of 20 weight-% for CaO; in individual instances however, maximum contents of 18, especially a maximum of 15 weight-% are sufficient. Even though the inventive glass may also be free of calcium components it does however usually contain at least 1 weight-% CaO, whereby contents of at least 2 weight-%, especially 3 weight-% are preferred. In practical applications a minimum content of 4 weight-% has been advantageous. The lower limit for MgO is, in individual instances 0 weight-%, whereby however at least 1 weight-% and preferably at least 2 weight-% are preferred. The maximum MgO content in the glass according to the invention is 8 weight-%, whereby a maximum of 7 and especially a maximum of 6 weight-% are preferred. SrO and/or BaO may be totally eliminated from the glass according to the invention; however, at least one or even both substances would preferably be present in an amount of 1 weight-%, preferably at least 2 weight-% respectively. The total content of all alkaline earth oxides contained in the glass amounts to at least 3 weight-% and at most 30 weight-%, especially 20 weight-%, whereby a minimum content of 4 weight-%, especially 5 weight-% is preferred. In many instances minimum contents of 6 or 7 weight-% have been advantageous. One preferred maximum limit of alkaline earth oxides is 18 weight-%, whereby a maximum of 15 weight-% is preferred. In several instances a maximum content of 12 weight-% has been established to be sufficient.

In accordance with the second embodiment the glass may be free of ZnO. However, it preferably contains a minimum amount of 0.1 weight-% and a maximum content of 30 weight-% at most, especially 8 weight-%, preferably 5 weight-% at most, whereby maximum contents of 3 weight-% or 2 weight-% may still be absolutely practical. The ZrO₂ content is preferably 0-8 weight-%, especially 0-5 weight-%, whereby a maximum content of 3 weight-% has proven to be sufficient in many instances.

The maximum content of TiO₂ is preferably 10 weight-%, whereby 5 weight-% at most are preferred. A preferred minimum content of TiO₂ is 1 weight-%. The glass contains 0-5 weight-% PbO, whereby a maximum content of 2 weight-%, especially a maximum of 1 weight-% is advantageous. The glass is preferably lead free. The Fe₂O₃ and/or CeO₂ content are usually 0-5 weight-% each, whereby amounts of 0-1 and especially 0-0.5 weight-% are preferred. The content of MnO₂ and/or Nd₂O₃ is 0-5 weight-%, whereby amounts of 0-2, especially 0-1 weight-% are preferred. The components Bi₂O₃ and/or MoO₃ are each contained in amounts of 0-5 weight-%, preferably 0-4 weight-%. As₂O₃ and/or Sb₂O₃ are each contained in the inventive glass in an amount of 0-1 weight-%, whereby the minimum contents are preferably 0.1, especially 0.2 weight-%. The total content of Fe₂O₃, CeO₂, TiO₂, PbO, As₂O₃ and Sb₂O₃ is preferably 0.1-10 weight-%, especially preferably >1-8 weight-%. In a preferred embodiment the glass according to the invention contains possibly low amounts of SO₄²⁻ of 0-2 weight-%, as well as Cl— and/or F—, also always in an amount of 0-2 weight-% each.

It is of course self-evident that the total amounts of the selected components of each composition amount to a total of 100 weight-%.

Preferred compositions of the inventive glass envelopes are therefore in the following ranges:

| | | |
|---|---|---|
| SiO₂ | 55-85 | weight-% |
| B₂O₃ | 0-35 | weight-% |
| Al₂O₃ | 0-20 | weight-% |
| Li₂O | 0-10 | weight-% |
| Na₂O | 0-20 | weight-% |
| K₂O | 0-20 | weight-%, whereby the |
| Σ Li₂O + Na₂O + K₂O is | 0-25 | weight-%, and |
| MgO | 0-8 | weight-% |
| CaO | 0-20 | weight-% |
| SrO | 0-5 | weight-% |
| BaO | 0-45 | weight-%, especially |
| BaO | 0-5 | weight-%, whereby the |
| Σ MgO + CaO + SrO + BaO | 0-45 | weight-%, |
| is especially | 0-20 | weight-%, and |
| TiO₂ | 0-10 | weight-%, |
| is preferably | >0.5-10 | weight-% |
| ZrO₂ | 0-3 | weight-% |
| CeO₂ | 0-3 | weight-% |
| WO₃ | 0-3 | weight-% |
| Bi₂O₃ | 0-3 | weight-% |
| MoO₃ | 0-3 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

whereby the sum of Yb₂O₃, Sm₂O₃, Dy₂O₃, FeO and CuO is 0.3-45 weight-%, as well as possibly refining agents in the normal concentrations, especially chloride, sulfates, As₂O₃ and Sb₂O₃.

The inventive light sources preferably consist of the following composition:

| | | |
|---|---|---|
| SiO₂ | 55-79 | weight-% |
| B₂O₃ | 3-25 | weight-% |
| Al₂O₃ | 0-10 | weight-% |
| Li₂O | 0-10 | weight-% |
| Na₂O | 0-10 | weight-% |
| K₂O | 0-10 | weight-% whereby the |
| Σ Li₂O + Na₂O + K₂O is | 0.5-16 | weight-% and |
| MgO | 0-2 | weight-% |
| CaO | 0-3 | weight-% |
| SrO | 0-3 | weight-% |
| BaO | 0-41.2 | weight-%, especially |
| BaO | 0-3 | weight-% |
| ZnO | 0-30 | weight-%, especially |
| ZnO | 0-3 | weight-%, whereby the |
| Σ MgO + CaO + SrO + BaO + ZnO is | 0-30 | weight-%, |
| especially | 0-10 | weight-% and |
| ZrO₂ | 0-3 | weight-% |
| CeO₂ | 0-1 | weight-% |
| Fe₂O₃ | 0-1 | weight-% |
| WO₃ | 0-3 | weight-% |
| Bi₂O₃ | 0-3 | weight-% |
| MoO₃ | 0-3 | weight-% |
| TiO₂ | 0-10 | weight-% TiO₂ |
| is preferably | >0.5-10 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

whereby the sum of Yb₂O₃, Sm₂O₃, Dy₂O₃, FeO and CuO is 0.3-41.5 weight-%, as well possibly refining agents in the normal concentrations, especially chloride, sulfates, As₂O₃ and Sb₂O₃.

The glass envelope of the backlight system can include one of the following compositions:

| | | |
|---|---|---|
| SiO₂ | 60-74.7 | weight-% |
| B₂O₃ | ≧25-35 | weight-% |
| Al₂O₃ | 0-10 | weight-% |
| Li₂O | 0-10 | weight-% |
| Na₂O | 0-14.7 | weight-% |
| K₂O | 0-14.7 | weight-%, whereby the |
| Σ Li₂O + Na₂O + K₂O is | 0-14.7 | weight-% and |
| MgO | 0-8 | weight-% |
| CaO | 0-14.7 | weight-% |
| SrO | 0-5 | weight-% |
| BaO | 0-14.7 | weight, especially |
| BaO | 0-5 | weight-%, whereby the |
| Σ MgO + CaO + SrO + BaO is | 0-14.7 | weight-%, |
| especially | 0-14.7 | weight-%, and |
| ZnO | 0-14.7 | weight-%, e |
| especially | 0-3 | weight-% and |
| ZrO₂ | 0-5 | weight-% |
| TiO₂ | 0-10 | weight-% |
| Fe₂O₃ | 0-0.5 | weight-% |
| CeO₂ | 0-0.5 | weight-% |
| MnO₂ | 0-1 | weight-% |
| Nd₂O₃ | 0-1 | weight-% |
| WO₃ | 0-2 | weight-% |
| Bi₂O₃ | 0-5 | weight-% |
| MoO₃ | 0-5 | weight-% |
| As₂O₃ | 0-1 | weight-% |
| Sb₂O₃ | 0-1 | weight-% |
| SO₄²⁻ | 0-2 | weight-% |
| CI⁻ | 0-2 | weight-% |
| F⁻ | 0-2 | weight-%, whereby |
| Yb₂O₃ | 0-14.7 | weight-% |
| Sm₂O₃ | 0-14.7 | weight-% |
| Dy₂O₃ | 0-14.7 | weight-% |
| FeO | 0-10 | weight-% |
| CuO | 0-10 | weight-% |

whereby the sum of Yb₂O₃, Sm₂O₃, Dy₂O₃, FeO and CuO is 0.3-14.7 weight-% and the Σ Fe₂O₃ + CeO₂ + TiO₂ + PbO + As₂O₃ + Sb₂O₃ is 0-10 is weight-% and whereby optionally Σ PdO + PtO₃ + PtO₂ + PtO + RhO₂ + Rh₂O₃ + IrO₂ + Ir₂O₃ is 0.000001-0.1 weight-% as well as possibly refining agents in the normal concentrations.

In addition the aforementioned glass compositions may also be utilized for light devices where the electrodes are on the outside and where no fusing of the glass with the electrode lead-throughs occurs. These are the so-called EEFLs (external electrode fluorescent lamp). These types of EEFL-light devices are light devices without electrode lead-throughs. Since the engagement in the EEFL-backlights without electrodes occurs with the assistance of electric fields, glass compositions are especially suitable which distinguish themselves through good electrical characteristics and a low quotient of dielectric loss angle tan δ, as well as relative permittivity. Especially suitable are for example glass envelopes of the following composition, which can be added to the first design variation, described above.

For an EEFL discharge lamp the glass, therefore, possesses the preferred following composition:

| | | |
|---|---|---|
| SiO₂ | 55-84.6 | weight-% |
| B₂O₃ | 0.1-35 | weight-% |
| Al₂O₃ | 0-25 | weight-% |
| preferably | 0-20 | weight-% |
| Li₂O | <1.0 | weight-% |
| Na₂O | <3.0 | weight-% |
| K₂O | <5.0 | weight-% whereby |
| Σ Li₂O + Na₂O + K₂O is | <5.0 | weight-%, and |
| MgO | 0-8 | weight-% |
| CaO | 0-20 | weight-% |
| SrO | 0-20 | weight-% |
| BaO | 0-44.6 | weight-%, especially |
| BaO | 0-20 | weight-%, whereby |
| TiO₂ | 0-10 | weight-% is |
| preferably | >0.5-10 | weight-% |
| ZrO₂ | 0-3 | weight-% |
| CeO₂ | 0-10 | weight-% |
| Fe₂O₃ | 0-3 | weight-% |
| preferably | 0-1 | weight-% |
| WO₃ | 0-3 | weight-% |
| Bi₂O₃ | 0-44.6 | weight-% |
| MoO₃ | 0-3 | weight-% |
| ZnO | 0-15 | weight-% |
| preferably | 0-5 | weight-% |
| PbO | 0-44.6 | weight-%, whereby |

the ΣAl₂O₃ + B₂O₃ + BaO + PbO + Bi₂O₃ is 15-44.6 weight-%,
whereby Hf, Ta, W, Re, Os, Ir, Pt, La, Pr, Nd, Eu, Gd, Tb, Ho, Er, Tm,
and/or Lu are present in oxidic form at contents of 0-29.6 weight-%,
as well as possibly refining agents in the normal concentrations and

| | | |
|---|---|---|
| Yb₂O₃ | 0-29.9 | weight-% |
| Sm₂O₃ | 0-29.9 | weight-% |
| Dy₂O₃ | 0-29.9 | weight-% |
| FeO | 0-10 | weight-% |
| CuO | 0-10 | weight-% |

whereby the sum of Yb₂O₃, Sm₂O₃, Dy₂O₃, FeO
and CuO is 0.3-29.9 weight-% as well as possibly refining
agents in the normal concentrations.

An especially preferred embodiment for utilization as glass envelopes in EEFL lamps is also:

| | | |
|---|---|---|
| SiO₂ | 55-84.6 | weight-% |
| B₂O₃ | 0.1-29.6 | weight-% |
| Al₂O₃ | 0-20 | weight-% |
| Li₂O | <0.5 | weight-% |
| Na₂O | <0.5 | weight-% |
| K₂O | <0.5 | weight-%, whereby the |
| Σ Li₂O + Na₂O + K₂O is | <1.0 | weight-%, and |
| MgO | 0-8 | weight-% |
| CaO | 0-20 | weight-% |
| SrO | 0-20 | weight-% |
| BaO | 15-44.6 | weight-%, especially |
| BaO | 20-35 | weight-%, whereby the |
| Σ MgO + CaO + SrO + BaO is | 15-29.6 | weight-% |
| especially | 20-40 | weight-%, and |
| TiO₂ | 0-10 | weight-% |
| is preferably | >0.5-10 | weight-% |
| ZrO₂ | 0-3 | weight-% |
| CeO₂ | 0-10 | weight-% |
| preferably | 0-1 | weight-% |
| Fe₂O₃ | 0-1 | weight-%′ |
| WO₃ | 0-3 | weight-% |
| Bi₂O₃ | 0-29.6 | weight-% |
| MoO₃ | 0-3 | weight-% |
| ZnO | 0-10 | weight-% |
| Preferably | 0-5 | weight-% |
| PbO | 0-29.6 | weight-%, whereby |
| Yb₂O₃ | 0-29.9 | weight-% |
| Sm₂O₃ | 0-29.9 | weight-% |
| Dy₂O₃ | 0-29.9 | weight-% |
| FeO | 0-10 | weight-% |
| CuO | 0-10 | weight-% |
| Cs₂O | 0-29.6 | weight-% |

whereby the sum of Yb₂O₃, Sm₂O₃, Dy₂O₃, FeO and CuO is 0.3-29.9 weight-%, the Σ Al₂O₃ + B₂O₃ + BaO + Cs₂O + PbO + Bi₂O₃ is 15-44.6 weight-%, as well as possibly refining agents in the normal concentrations.

The glass is preferably free of alkalis, except for unavoidable impurities.

Additional preferred glass compositions for use in EEFL lamps include:

| | | |
|---|---|---|
| SiO₂ | 35-65 | weight-% |
| B₂O₃ | 0-15 | weight-% |
| Al₂O₃ | 0-20 | weight-% |
| Preferably | 5-15 | weight-% |
| Li₂O | 0-1.0 | weight-% |
| Na₂O | 0-10.0 | weight-% |
| K₂O | 0-6.0 | weight-%, whereby the |
| Σ Li₂O + Na₂O + K₂O is | 0-17 | weight-%, and |
| MgO | 0-6 | weight-% |
| CaO | 0-15 | weight-% |
| SrO | 0-8 | weight-% |
| BaO | 1-20 | weight-%, especially |
| BaO | 1-10 | weight-% |
| TiO₂ | 0-10 | weight-% |
| preferably | >0.5-10 | weight-% |
| ZrO₂ | 0-1 | weight-% |
| CeO₂ | 0-0.5 | weight-% |
| Fe₂O₃ | 0-0.5 | weight-% |
| WO₃ | 0-2 | weight-% |
| Bi₂O₃ | 0-20 | weight-% |
| MoO₃ | 0-5 | weight-% |
| ZnO | 0-5 | weight-% |
| Preferably | 0-3 | weight-% |
| PbO | 0-64.7 | weight-%, whereby |
| the Σ Al₂O₃ + B₂O₃ + BaO + PbO + | 8-64.7 | weight-%, |
| Bi₂O₃ is | | |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

whereby the sum of Yb₂O₃, Sm₂O₃, Dy₂O₃, FeO and CuO is 0.3-50 weight-% as well as possibly refining agents in the normal concentrations.

Additional glasses which like the aforementioned glass compositions, also have a quotient of tan δ/∈′<5×10⁻⁴ due to the presence of at least one highly polarizable oxide at relatively high amounts, and which are especially advantageous for use in EEFL lamps, include the following composition:

| | | |
|---|---|---|
| SiO₂ | 50-65 | weight-% |
| B₂O₃ | 0-15 | weight-% |
| Al₂O₃ | 1-17 | weight-% |
| Li₂O | 0-0.5 | weight-% |
| Na₂O | 0-0.5 | weight-% |
| K₂O | 0-0.5 | weight-%, whereby the |
| Σ Li₂O + Na₂O + K₂O is | 0-1 | weight-%, and |
| MgO | 0-5 | weight-% |
| CaO | 0-15 | weight-% |
| SrO | 0-5 | weight-% |
| BaO | 20-48.7 | weight-%, especially |
| BaO | 20-40 | weight-% |
| TiO₂ | 0-1 | weight-% |
| ZrO₂ | 0-1 | weight-% |
| CeO₂ | 0-0.5 | weight-% |
| Fe₂O₃ | 0-0.1 | weight-% |
| preferably | 0-0.5 | weight-% |
| WO₃ | 0-2 | weight-% |
| Bi₂O₃ | 0-28.7 | weight-% |
| MoO₃ | 0-5 | weight-% |
| ZnO | 0-3 | weight-% |
| PbO | 0-28.7 | weight-%, especially |
| PbO | 10-20 | weight-%, whereby |
| Yb₂O₃ | 0-18.7 | weight-% |
| Sm₂O₃ | 0-18.7 | weight-% |
| Dy₂O₃ | 0-18.7 | weight-% |
| FeO | 0-10 | weight-% |
| CuO | 0-10 | weight-% |

whereby the sum of Yb₂O₃, Sm₂O₃, Dy₂O₃, FeO and CuO is 0.3-29 weight-%, the ΣAl₂O₃ + B₂O₃ + BaO + PbO + Bi₂O₃ is 21-49.7 weight-%, whereby Hf, Ta, W, Re, Os, Ir, Pt, La, Pr, Nd, Eu, Gd, Tb, Ho, Er, Tm, and/or Lu are present in oxidic form at a content of 0-28.7 weight-%, as well as refining agents in the usual concentrations.

In addition, the following glass compositions are preferred, independent of the used light devices:

| | | |
|---|---|---|
| SiO₂ | 63-72 | weight-% |
| B₂O₃ | 15-20.2 | weight-% |
| Al₂O₃ | 0-5 | weight-% |
| Li₂O | 0-5 | weight-% |
| Na₂O | 0-8 | weight-% |
| K₂O | 0-8 | weight-%, whereby the |
| Σ Li₂O + Na₂O + K₂O is | 0.5-10 | weight-%, and |
| MgO | 0-3 | weight-% |
| CaO | 0-5 | weight-% |
| SrO | 0-3 | weight-% |
| BaO | 0-20.2 | weight-%, especially |
| BaO | 0-3 | weight-%, whereby the |
| Σ MgO + CaO + SrO + BaO is | 0-20.2 | weight-% |
| especially | 0-5 | weight-%, and |
| ZnO | 0-20.2 | weight-%, especially |
| ZnO | 0-3 | weight-% |
| ZrO₂ | 0-5 | weight-% |
| TiO₂ | >0.5-10 | weight-% |
| CeO₂ | 0-0.5 | weight-% |
| MnO₂ | 0-1.0 | weight-% |
| Nd₂O₃ | 0-1.0 | weight-% |
| WO₃ | 0-2 | weight-% |
| Bi₂O₃ | 0-5 | weight-% |
| MoO₃ | 0-5 | weight-% |
| As₂O₃ | 0-1 | weight-% |
| Sb₂O₃ | 0-1 | weight-% |
| SO₄⁽²⁻⁾ | 0-2 | weight-% |
| Cl⁻ | 0-2 | weight-% |
| F⁻ | 0-2 | weight-%, whereby |
| Yb₂O₃ | 0-20.5 | weight-% |
| Sm₂O₃ | 0-20.5 | weight-% |
| Dy₂O₃ | 0-20.5 | weight-% |
| FeO | 0-10 | weight-% |
| CuO | 0-10 | weight-% |

whereby the sum of Yb₂O₃, Sm₂O₃, Dy₂O₃, FeO and CuO is 0.3-20.5 weight-%, and the Σ Fe₂O₃ + CeO₂ + TiO₂ + PbO + As₂O₃ + Sb₂O₃ is 0.5-10 weight-%, as well as possibly refining agents in the normal concentrations.

An additional preferred composition contains:

| | | |
|---|---|---|
| SiO₂ | 67-74 | weight-% |
| B₂O₃ | 5-10 | weight-% |
| Al₂O₃ | 3-10 | weight-% |
| Li₂O | 0-4 | weight-% |
| Na₂O | 0-10 | weight-% |
| K₂O | 0-10 | weight-%, whereby the |
| Σ Li₂O + Na₂O + K₂O is | 0.5-10.5 | weight-% |
| MgO | 0-2 | weight-% |
| CaO | 0-3 | weight-% |
| SrO | 0-3 | weight-% |
| BaO | 0-24.1 | weight-%, especially |
| BaO | 0-3 | weight-% |
| ZnO | 0-24.1 | weight-%, especially |
| ZnO | 0-3 | weight-%, whereby the |
| Σ MgO + CaO + SrO + BaO + ZnO is | 0-24.1 | weight-%, |
| especially | 0-6 | weight-% |
| ZrO₂ | 0-3 | weight-% |
| CeO₂ | 0-1 | weight-% |

and that TiO₂, Bi₂O₃ and/or MoO₃ are contained in an
amount - always independent of each other - of 0-10 weight-%,
whereby Σ TiO₂ + Bi₂O₃ + MoO₃ are 0.1-10 weight-% as well as

| | | |
|---|---|---|
| Yb₂O₃ | 0-24.4 | weight-% |
| Sm₂O₃ | 0-24.4 | weight-% |
| Dy₂O₃ | 0-24.4 | weight-% |
| FeO | 0-10 | weight-% |
| CuO | 0-10 | weight-% |

whereby the sum of Yb₂O₃, Sm₂O₃, Dy₂O₃, FeO and CuO is 0.3-24.4
weight-%, as well as possibly refining agents in normal concentrations.

The following glass compositions are also especially suitable for light devices, especially lamps which have electrodes on the outside, with electrode lead-throughs, whereby no fusing into the glass occurs. In addition these distinguish themselves through a high chemical resistance to acids, caustic solutions and water and are to be included in the invention in a second design variation:

| | | |
|---|---|---|
| SiO₂ | 60-85 | weight-% |
| B₂O₃ | 0-10 | weight-% |
| Al₂O₃ | 0-10 | weight-% |
| Li₂O | 0-10 | weight-% |
| Na₂O | 0-20 | weight-% |
| K₂O | 0-20 | weight-%, whereby the |
| Σ Li₂O + Na₂O + K₂O is | 5-25 | weight-% and |
| MgO | 0-8 | weight-% |
| CaO | 0-20 | weight-% |
| SrO | 0-5 | weight-% |
| BaO | 0-30 | weight-%, especially |
| BaO | 0-5 | weight-%, whereby the |
| Σ MgO + CaO + SrO + BaO is | 3-30 | weight-% |
| and especially | 3-20 | weight-%, and |
| ZnO | 0-20 | weight-%, especially |
| ZnO | 0-8 | weight-% |
| ZrO₂ | 0-5 | weight-% |
| TiO₂ | 0-10 | weight-% |
| Fe₂O₃ | 0-5 | weight-% |
| CeO₂ | 0-5 | weight-% |
| MnO₂ | 0-5 | weight-% |
| Nd₂O₃ | 0-1.0 | weight-% |
| WO₃ | 0-2 | weight-% |
| Bi₂O₃ | 0-5 | weight-% |
| MoO3 | 0-5 | weight-% |
| PbO | 0-5 | weight-% |
| As₂O₃ | 0-1 | weight-% |
| Sb₂O₃ | 0-1 | weight-% |

whereby the
Σ Fe₂O₃ + CeO₂ + TiO₂ + PbO + As₂O₃ + Sb₂O₃
is 0-10 weight-%
and whereby optionally the
Σ PdO + PtO₃ + PtO₂ + PtO + RhO₂ + Rh₂O₃ + IrO₂ + Ir₂O₃
is 0.1 weight-%, as well as

| | | |
|---|---|---|
| SO₄²⁻ | 0-2 | weight-% |
| Cl⁻ | 0-2 | weight-% |
| F⁻ | 0-2 | weight-% |
| Yb₂O₃ | 0-31.9 | weight-% |
| Sm₂O₃ | 0-31.9 | weight-% |
| Dy₂O₃ | 0-31.9 | weight-% |
| FeO | 0-10 | weight-% |
| CuO | 0-10 | weight-% |

whereby the sum of Yb₂O₃, Sm₂O₃, Dy₂O₃, FeO and CuO is 0.3-31.9
weight-%, as well as possibly refining agents in normal concentrations.

In accordance with the first and the second embodiment the glasses are especially suitable for the production of flat glass, particularly in the float process, whereby the production of tube glass is especially preferred. It is especially suitable for the production of tubes having a diameter of at least 0.5 mm, especially at least 1 mm and a maximum of 2 cm, especially a maximum of 1 cm. Especially preferred tube diameters are between 2 mm and 5 mm. It has been demonstrated that tubes of this type possess a wall thickness of at least 0.05 mm, especially at least 0.1 mm, whereby at least 0.2 mm is especially preferred. Maximum wall thicknesses are 1 mm at most, whereby wall thicknesses of <0.8 mm or <0.7 mm maximum are preferred.

The glasses cited for use with the light devices according to the invention are particularly suitable for utilization in fluorescent lamps with external electrodes, as well as in fluorescent lamps where the electrodes are fused with the lamp glass and penetrate through said glass, as is the case for example in Kovar alloys, molybdenum and wolfram, etc. With external electrodes these may, for example be formed through an electro-conductive paste.

An additionally preferred application for the glasses described herein is in the form of flat glass for flat gas discharge lamps.

The cited glasses are preferably formed initially to a semi-finished product. The production of the semi-finished products for example through a hot forming process may occur, for example, directly from the melted mass. A tube is produced, for example, whereby the liquid glass runs from the melting tank onto a so-called “Danner” blow pipe and is drawn from there into a tube. The tube may also be produced by way of other processes, for example way of the Velo-draw or A-draw. Experts are familiar with these processes.

Flat glass may be produced in an up-draw or down-draw process, or in the float process. These processes are also known to the expert. Hollow glass may be pressed or blown.

The glasses cited in this application, especially borosilicate glasses, are especially suitable for use in gas discharge tubes, such as fluorescent lamps, especially miniaturized fluorescent lamps. They are especially suitable for illumination, especially backlighting of electronic display units such as displays and LCD screens as are used for example in cell phones and computer monitors and find application as a light source in the production of liquid crystal displays (LCD) as well as backlit displays (passive displays, so-called displays with a backlight unit). Such fluorescent lights have very small dimensions for these applications and accordingly, the lamp glass thickness is extremely insignificant. Preferred displays, such as screens are so-called flat screen displays, as used in laptops, especially flat backlight arrangements. Halogen-free light devices are especially preferred, for example the type that is based on the discharging of xenon atoms (xenon lamps). This arrangement has proven to be especially environmentally friendly.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a light device, preferably in the embodiment of a so-called backlight with electrodes, which lead into the interior of the glass bulb;

FIG. 2 is the basic form of a reflecting base or support and substrate plate for a miniaturized backlight arrangement;

FIG. 3 is a backlight arrangement with electrodes on the outside and

FIG. 4 is a display arrangement with side-mounted fluorescent lamps.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

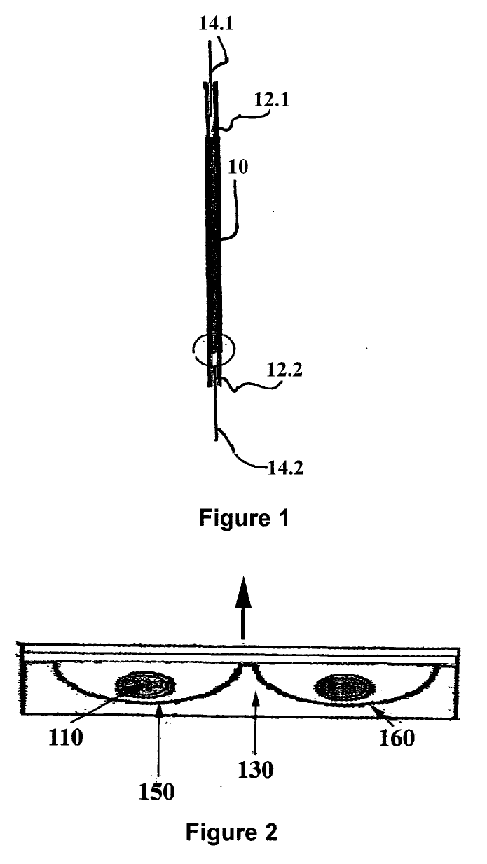

Referring now to the drawings, and more particularly to FIG. 1, there is shown a the principle view of a low pressure discharge lamp, especially a fluorescent lamp, most especially preferred a miniaturized fluorescent lamp.

FIG. 1 illustrates the principle view of a low pressure discharge lamp, especially a fluorescent lamp, most especially preferred a miniaturized fluorescent lamp.

FIG. 1 illustrates a so-called backlight lamp which is produced from tube glass. The mid section 10 is largely transparent and represents the lamp body. Metal wires 14.1, 14.2 of the lead-throughs are inserted into the two open ends 12.1, 12.2. These may, for example be fused with the transparent tube glass during a tempering process. The selection of the glass with regard to the area of the lead-throughs is made preferably so that the expansion coefficient of the glass coincides largely with the expansion coefficient of the metal wires 14.1, 14.2.

In accordance with the current invention the envelope glass of the backlight-lamp can be doped with one or a plurality of doping oxides, preferably selected from example ytterbium-oxide, dysprosium-oxide, samarium-oxide, iron(II)oxide and copper(II)oxide, as well as compounds. Alternatively, or in addition an outside coating selected preferably from SiO2 and TiO₂ layers, or SiO₂ and Ta₂O₅ layers, S₂O₂ and Nb₂O₂ layers, SiO₂ and Y₂O₃ layers, SiO₂ and ZrO₂ layers can be applied (not illustrated). As a rule, the layer systems consisting of the aforementioned substances are interference layer systems consisting of 20 or more layers. Other possible coatings are layers of conductive oxidic layers, for example consisting of In₂O₃, SnO₂, as well as ZnO, possibly doped with Sn or F in order to increase the conductivity and IR-reflection.

Alternatively, coatings consisting of a thin metallic layer, for example of silver or a silver-based layer system are also feasible.

FIGS. 2 through 4 illustrate examples of the use of a backlight lamp in various backlight systems, whereby protection from undesirable IR-rays is provided in accordance with the current invention.

FIG. 2 shows a special use for such applications, whereby individual miniaturized fluorescent tubes 110 are utilized parallel to each other and are located in a plate 130 in which there are recesses 150 which reflect the transmitted light on the display. A reflective layer 160 is applied above the reflecting plate 130 which, acting as a type of reflector evenly scatters the light which is radiated from the fluorescent tube 110 in the direction of the plate 130, thereby ensuring a homogenous illumination of the display. This type of arrangement is preferred for larger displays, for example TVs.

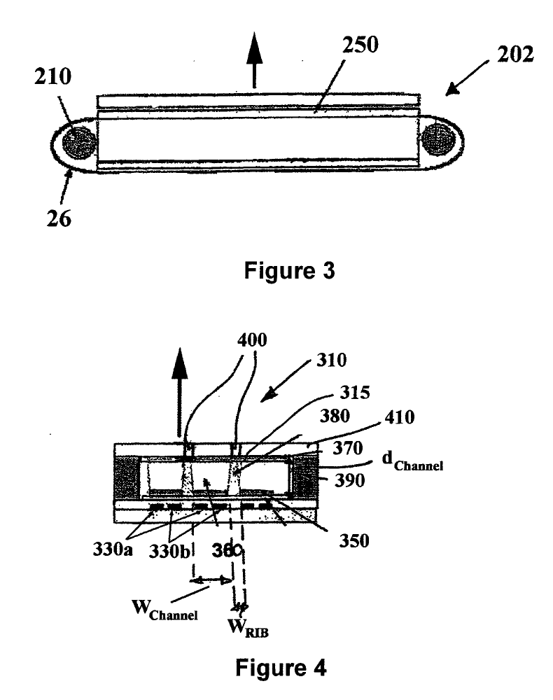

In accordance with the design variation illustrated in FIG. 3, the light source 210 can also be mounted on the outside on the display 202, whereby the light then is released evenly over the display by way of a light transporting plate 250—a so-called LGP (light guide plate). Light transporting plates of this type possess for example, a rough surface over which the light is released. The light sources may have external or internal electrodes.

In addition it is also possible to utilize it for such backlight arrangements where the light producing unit 310 is located directly in a structured disk 315. This is depicted in FIG. 4. This structure is configured so that channels having a predetermined depth and predetermined width (d_{channel} or W_{channel}) and in which the discharge illumination substance 380 is located are created in said disk by way of parallel ribs or so-called barriers 380 which have a predetermined width (W_{rib}). The channels, together with a panel 370 that is covered in a phosphorous layer, form radiation chambers 360.

The backlight arrangement illustrated in FIG. 4 is a gas discharge lamp without electrodes, in other words there are no lead-throughs, only exterior electrodes 330a, 330b. Depending upon the system configuration, the cover plate or panel 410 depicted in FIG. 4 may be an opaque diffuser panel or a clear transparent panel.

The electrode-free lamp system illustrated in FIG. 4 is known as a so-called EEFL system (external electrode fluorescent lamp). The previously described arrangements form a large flat backlight and are therefore also described as flat backlight.

One or several components of the backlight arrangements which are schematically depicted in FIGS. 2 through 4 may, according to the invention have an IR-radiation absorbing coating (not illustrated). This may for example be the support plate, the cover plate or disk, a side surface of the backlight arrangement or light distribution unit or sections thereof.

The current invention is further explained below with the assistance of examples which will clarify the inventive science, but which are not intended in any way to restrict said science.

### EXAMPLES OF EMBODIMENTS

The following tables 1 through 3 show different inventive glass compositions which, when utilized in glass envelopes for light sources in backlight systems absorb the undesirable IR-radiation, thanks to appropriate doping with doping oxides:

TABLE 1

| | Arrange- | Arrange- | Arrange- | Arrange- | Arrange- |
|---|---|---|---|---|---|
| Weight-% | ment 1 | ment 2 | ment 3 | ment 4 | ment 5 |
| SiO₂ | 55.1 | 62.4 | 39 | 55 | 64.8 |
| B₂O₃ | 16.9 | 17.5 | 15 | 16 | 19 |
| Al₂O₃ | 2.6 | 2 | 2.6 | 2.6 | 2.6 |
| ZnO | 0.6 | 0.6 | 0.6 | 0.6 | 0.6 |
| TiO₂ | 3.5 | 4.5 | 5.5 | 5 | |
| Na₂O | 0.7 | 0.5 | 0.7 | 0.7 | 0.7 |
| Li₂O | 0.6 | 0.5 | 0.6 | 0.6 | 0.6 |
| K₂O | 5.5 | 7 | 6 | 7.5 | 7.7 |
| Yb₂ | 14.5 | 5 | 30 | 2 | |
| Sm₂O₃ | | | | 5 | |
| Dy₂O₃ | | | | 5 | |
| FeO | | | | | 4 |
| CuO | | | | | |
| Sum | 100 | 100 | 100 | 100 | 100 |

TABLE 2

| | Arrange- | Arrange- | Arrange- | Arrange- | Arrange- |
|---|---|---|---|---|---|
| Weight-% | ment 6 | ment 7 | ment 8 | ment 9 | ment 10 |
| SiO₂ | 62 | 65 | 45 | 66 | 71.6 |
| B₂O₃ | 13.5 | 17.5 | 15 | 16 | 17 |
| Al₂O₃ | 1 | 1.2 | 1.1 | 1.1 | 1.1 |
| Na₂O | 3 | 3.9 | 3 | 3 | 3.8 |
| K₂O | 2 | 2 | 1.5 | 1.5 | 1.5 |
| CaO | 0.6 | 0.8 | 0.6 | 0.6 | 0.6 |
| MgO | 0.4 | 0.6 | 0.4 | 0.4 | 0.4 |
| TiO₂ | 3.5 | 4 | 4 | 4.4 | |
| Yb₂ | 14 | 5 | 29.4 | 2 | |
| Sm₂O₃ | | | | 5 | |
| Dy₂O₃ | | | | | |
| FeO | | | | | 3 |
| CuO | | | | | 1 |
| Sum | 100 | 100 | 100 | 100 | 100 |

TABLE 3

| | Arrange- | Arrange- | | |
|---|---|---|---|---|
| | ment 11 | ment 12 | Arrangement 13 | Arrangement 14 |
| SiO₂ | 40.60 | 40.00 | 61.10 | 60.50 |
| B₂O₃ | 6.10 | 6.00 | 6.10 | 6.00 |
| Al₂O₃ | | | | |
| P₂O₅ | | | | |
| PbO | | | | |
| Bi₂O₃ | | | | |
| Lo₂P | 1.00 | 1.00 | 1.00 | 1.00 |
| Na₂O | 9.90 | 10.00 | 9.90 | 10.00 |
| K₂O | 3.30 | 3.00 | 3.30 | 3.00 |
| Rb₂O | | | | |
| Cs₂O | | | | |
| Ag₂O | | | | |
| MgO | | | | |
| CaO | | | | |
| SrO | | | | |
| BaO | 5.20 | 5.00 | 5.20 | 5.00 |
| ZnO | 3.40 | 3.50 | 3.40 | 3.50 |
| TiO₂ | 0.50 | 0.50 | 0.50 | 0.50 |
| ZrO₂ | | | | |
| SnO₂ | | | | |
| Nb₂O₅ | | | | |
| Ta₂O₅ | | | | |
| WO₃ | | | | |
| Y₂O₃ | | | | |
| Yb₂O₃ | | 35.50 | | 10.00 |
| La₂O₃ | | | | |
| CeO₂ | 0.50 | 0.50 | 0.50 | 0.50 |
| Ce₂O₃ | | | | |
| Pr₂O₃ | | | | |
| Nd₂O₃ | | | | |
| Sm₂O₃ | | | | |
| Eu₂O₃ | | | | |
| Gd₃O₃ | | | | |
| Weight-% | | | | |
| Tb₂O₃ | | | | |
| Dy₂O₃ | 29.50 | | 9.00 | |
| Er₂O₃ | | | | |
| Fe₂O₃ | | | | |
| FeO | | | | |
| CoO | | | | |
| Sum | 100.00 | 100.0 | 100.00 | 100.00 |

The current invention provides, for the first time a backlight system which makes it possible to absorb undesirable IR-radiation. This may be achieved by providing an appropriately doped glass envelope for the light source and/or a coating of other components of the light source, thus avoiding malfunctions during operation of such backlight systems.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A backlight system for background illumination of one of a display and a screen, said backlight system comprising:
at least one light source including a glass envelope having a glass composition, at least one of
(a) said glass composition of said glass envelope being doped with at least one doping oxide which absorbs IR-radiation,
(b) said glass envelope including a first coating which absorbs said IR-radiation and which is at least one of an outside coating and an inside coating, and
(c) the backlight system including a second coating and a plurality of components other than said glass envelope, said second coating being on said plurality of components and absorbing said IR-radiation.

2. The backlight system according to claim 1, wherein said at least one doping oxide is selected from at least one of ytterbium-oxide, dysprosium-oxide, samarium-oxide, iron(II)oxide, copper(II)oxide, and at least one compound thereof.

3. The backlight system according to claim 2, wherein said plurality of components having thereon said second coating absorbing said IR-radiation includes at least one of said light distributing unit, a diffuser plate, one of a support plate and a support disk, one of a cover plate and a protective plate, at least partial surfaces or sections of the backlight system, and components thereof.

4. The backlight system according to claim 1, wherein at least one of said first coating and said second coating is also IR-reflecting.

5. The backlight system according to claim 1, wherein at least one of said first coating and said second coating is selected from one or a combination of the following:
SiO₂ and TiO₂ layers,
SiO₂ and Ta₂O₅ layers,
S₂O₂ and Nb₂O₂ layers,
SiO₂ and Y₂O₃ layers,
SiO₂ and ZrO₂ layers,
Transparent conductive layers,
In₂O₃ layers,
SnO₂ layer,
ZnO layers,
Transparent conductive layers, doped with Sn, F,
In₂O₃ layers doped with Sn, F,
SnO₂ layers doped with Sn, F,
ZnO layers doped with Sn, F,
Silver layers, and
Silver-based layer systems.

6. The backlight system according to claim 1, wherein said at least one light source is a discharge lamp.

7. The backlight system according to claim 6, wherein said discharge lamp includes a discharge chamber which is filled with a plurality of discharge substances including at least one of neon, argon, xenon, rare earth ions, and mercury.

8. The backlight system according to claim 6, wherein said glass envelope of said discharge lamp includes an inside and a fluorescent layer applied on said inside.

9. The backlight system according to claim 1, wherein said glass envelope includes one of the following compositions:

| | | |
|---|---|---|
| SiO₂ | 55-85 | weight-% |
| B₂O₃ | 0-35 | weight-% |
| Al₂O₃ | 0-20 | weight-% |
| Li₂O | 0-10 | weight-% |
| Na₂O | 0-20 | weight-% |
| K₂O | 0-20 | weight-%, wherein the |
| Σ Li₂O + Na₂O + K₂O is | 0-25 | weight-%, and |
| MgO | 0-8 | weight-% |
| CaO | 0-20 | weight-% |
| SrO | 0-5 | weight-% |
| BaO | 0-45 | weight-%, wherein the |
| Σ MgO + CaO + SrO + BaO | 0-45 | weight-%, and |
| TiO₂ | 0-10 | weight-% |
| ZrO₂ | 0-3 | weight-% |
| CeO₂ | 0-3 | weight-% |
| WO₃ | 0-3 | weight-% |
| Bi₂O₃ | 0-3 | weight-% |
| MoO₃ | 0-3 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

wherein the sum of Yb₂O₃, Sm₂O₃, Dy₂O₃, FeO, and CuO is 0.3-45 weight-%, and at least one refining agent, in normal concentrations, including at least one of chloride, sulfates, As₂O₃, and Sb₂O₃.

10. The backlight system according to claim 1, wherein said glass envelope includes one of the following compositions:

| | | |
|---|---|---|
| SiO₂ | 55-79 | weight-% |
| B₂O₃ | 3-25 | weight-% |
| Al₂O₃ | 0-10 | weight-% |
| Li₂O | 0-10 | weight-% |
| Na₂O | 0-10 | weight-% |
| K₂O | 0-10 | weight-% wherein the |
| Σ Li₂O + Na₂O + K₂O is | 0.5-16 | weight-% and |
| MgO | 0-2 | weight-% |
| CaO | 0-3 | weight-% |
| SrO | 0-3 | weight-% |
| BaO | 0-41.2 | weight-% |
| ZnO | 0-30 | weight-%, wherein the |
| Σ MgO + CaO + SrO + BaO + ZnO is | 0-30 | weight-%, and |
| ZrO₂ | 0-3 | weight-% |
| CeO₂ | 0-1 | weight-% |
| Fe₂O₃ | 0-1 | weight-% |
| WO₃ | 0-3 | weight-% |
| Bi₂O₃ | 0-3 | weight-% |
| MoO₃ | 0-3 | weight-% |
| TiO₂ | 0-10 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

wherein the sum of Yb₂O₃, Sm₂O₃, Dy₂O₃, FeO, and CuO is 0.3-41.5 weight-%, and at least one refining agent, in normal concentrations, including at least one of chloride, sulfates, As₂O₃, and Sb₂O₃.

11. The backlight system according to claim 1, wherein said glass envelope includes one of the following compositions:

| | | |
|---|---|---|
| SiO₂ | 60-74.7 | weight-% |
| B₂O₃ | ≧25-35 | weight-% |
| Al₂O₃ | 0-10 | weight-% |
| Li₂O | 0-10 | weight-% |
| Na₂O | 0-14.7 | weight-% |
| K₂O | 0-14.7 | weight-%, wherein the |
| Σ Li₂O + Na₂O + K₂O is | 0-14.7 | weight-% and |
| MgO | 0-8 | weight-% |
| CaO | 0-14.7 | weight-% |
| SrO | 0-5 | weight-% |
| BaO | 0-14.7 | weight, wherein the |
| Σ MgO + CaO + SrO + BaO is | 0-14.7 | weight-%, and |
| ZnO | 0-14.7 | weight-%, and |
| ZrO₂ | 0-5 | weight-% |
| TiO₂ | 0-10 | weight-% |
| Fe₂O₃ | 0-0.5 | weight-% |
| CeO₂ | 0-0.5 | weight-% |
| MnO₂ | 0-1 | weight-% |
| Nd₂O₃ | 0-1 | weight-% |
| WO₃ | 0-2 | weight-% |
| Bi₂O₃ | 0-5 | weight-% |
| MoO₃ | 0-5 | weight-% |
| As₂O₃ | 0-1 | weight-% |
| Sb₂O₃ | 0-1 | weight-% |
| SO₄²⁻ | 0-2 | weight-% |
| Cl⁻ | 0-2 | weight-% |
| F⁻ | 0-2 | weight-%, wherein |
| Yb₂O₃ | 0-14.7 | weight-% |
| Sm₂O₃ | 0-14.7 | weight-% |
| Dy₂O₃ | 0-14.7 | weight-% |
| FeO | 0-10 | weight-% |
| CuO | 0-10 | weight-% |

wherein the sum of Yb₂O₃, Sm₂O₃, Dy₂O₃, FeO and CuO is 0.3-14.7 weight-%, the Σ Fe₂O₃ + CeO₂ + TiO₂ + PbO + As₂O₃ + Sb₂O₃ is 0-10 is weight-% and wherein the Σ PdO + PtO₃ + PtO₂ + PtO + RhO₂ + Rh₂O₃ + IrO₂ + Ir₂O₃ is 0.000001-0.1 weight-% and at least one refining agent in normal concentrations.

12. The backlight system according to claims 1, wherein said glass envelope, which is configured for being used in an external electrode fluorescent lamp, includes one of the following compositions:

| | | |
|---|---|---|
| SiO₂ | 55-84.6 | weight-% |
| B₂O₃ | 0.1-35 | weight-% |
| Al₂O₃ | 0-25 | weight-% |
| Li₂O | <1.0 | weight-% |
| Na₂O | <3.0 | weight-% |
| K₂O | <5.0 | weight-% wherein |
| Σ Li₂O + Na₂O + K₂O is | <5.0 | weight-%, and |
| MgO | 0-8 | weight-% |
| CaO | 0-20 | weight-% |
| SrO | 0-20 | weight-% |
| BaO | 0-44.6 | weight-%, wherein |
| TiO₂ | 0-10 | weight-% |
| ZrO₂ | 0-3 | weight-% |
| CeO₂ | 0-10 | weight-% |
| Fe₂O₃ | 0-3 | weight-% |
| WO₃ | 0-3 | weight-% |
| Bi₂O₃ | 0-44.6 | weight-% |
| MoO₃ | 0-3 | weight-% |
| ZnO | 0-15 | weight-% |
| PbO | 0-44.6 | weight-%, wherein |

the ΣAl₂O₃ + B₂O₃ + BaO + PbO + Bi₂O₃ is 15-44.6 weight-%,
wherein at least one of Hf, Ta, W, Re, Os, Ir, Pt, La, Pr, Nd, Eu, Gd,
Tb, Ho, Er, Tm, and Lu is present in oxidic form at contents of 0-29.6
weight-%, and at least one refining agent in normal concentrations, and

| | | |
|---|---|---|
| Yb₂O₃ | 0-29.6 | weight-% |
| Sm₂O₃ | 0-29.6 | weight-% |
| Dy₂O₃ | 0-29.6 | weight-% |
| FeO | 0-10 | weight-% |
| CuO | 0-10 | weight-% |

wherein the sum of Yb₂O₃, Sm₂O₃, Dy₂O₃, FeO and CuO is 0.3-29.6
weight-%.

13. The backlight system according to claim 1, wherein said glass envelope, which is configured for being used in an external electrode fluorescent lamp, includes one of the following compositions:

| | | |
|---|---|---|
| SiO₂ | 55-84.6 | weight-% |
| B₂O₃ | 0.1-29.6 | weight-% |
| Al₂O₃ | 0-20 | weight-% |
| Li₂O | <0.5 | weight-% |
| Na₂O | <0.5 | weight-% |
| K₂O | <0.5 | weight-%, wherein the |
| Σ Li₂O + Na₂O + K₂O is | <1.0 | weight-%, and |
| MgO | 0-8 | weight-% |
| CaO | 0-20 | weight-% |
| SrO | 0-20 | weight-% |
| BaO | 15-44.6 | weight-%, wherein the |
| Σ MgO + CaO + SrO + BaO is | 15-29.6 | weight-%, and |
| TiO₂ | 0-10 | weight-% |
| ZrO₂ | 0-3 | weight-% |
| CeO₂ | 0-10 | weight-% |
| Fe₂O₃ | 0-1 | weight-% |
| WO₃ | 0-3 | weight-% |
| Bi₂O₃ | 0-29.6 | weight-% |
| MoO₃ | 0-3 | weight-% |
| ZnO | 0-10 | weight-% |
| PbO | 0-29.6 | weight-%, wherein |
| Yb₂O₃ | 0-29.9 | weight-% |
| Sm₂O₃ | 0-29.9 | weight-% |
| Dy₂O₃ | 0-29.9 | weight-% |
| FeO | 0-10 | weight-% |
| CuO | 0-10 | weight-% |
| Cs₂O | 0-29.9 | weight-% |

wherein the sum of Yb₂O₃, Sm₂O₃, Dy₂O₃, FeO and CuO is 0.3-29.9 weight-%, the Σ Al₂O₃ + B₂O₃ + BaO + Cs₂O + PbO + Bi₂O₃ is 15-44.6 weight-%, and at least one refining agent in normal concentrations, wherein said glass envelope is free of alkalis except for any unavoidable impurities.

14. The backlight system according to claim 1, wherein said glass envelope, which is configured for being used in an external electrode fluorescent lamp, includes one of the following compositions:

| | | |
|---|---|---|
| SiO₂ | 35-65 | weight-% |
| B₂O₃ | 0-15 | weight-% |
| Al₂O₃ | 0-20 | weight-% |
| Li₂O | 0-1.0 | weight-% |
| Na₂O | 0-10.0 | weight-% |
| K₂O | 0-6.0 | weight-%, wherein the |
| Σ Li₂O + Na₂O + K₂O is | 0-17 | weight-%, and |
| MgO | 0-6 | weight-% |
| CaO | 0-15 | weight-% |
| SrO | 0-8 | weight-% |
| BaO | 1-20 | weight-% |
| TiO₂ | 0-10 | weight-% |
| ZrO₂ | 0-1 | weight-% |
| CeO₂ | 0-0.5 | weight-% |
| Fe₂O₃ | 0-0.5 | weight-% |
| WO₃ | 0-2 | weight-% |
| Bi₂O₃ | 0-20 | weight-% |
| MoO₃ | 0-5 | weight-% |
| ZnO | 0-5 | weight-% |
| PbO | 0-64.7 | weight-%, wherein |
| the Σ Al₂O₃ + B₂O₃ + | 8-64.7 | weight-%, |
| BaO + PbO + Bi₂O₃ is | | |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

wherein the sum of Yb₂O₃, Sm₂O₃, Dy₂O₃, FeO and CuO is 0.3-50
weight-%, and at least one refining agent in normal concentrations.

15. The backlight system according to claim 1, wherein said glass envelope, which is configured for being used in an external electrode fluorescent lamp, includes one of the following compositions:

| | | |
|---|---|---|
| SiO₂ | 50-65 | weight-% |
| B₂O₃ | 0-15 | weight-% |
| Al₂O₃ | 1-17 | weight-% |
| Li₂O | 0-0.5 | weight-% |
| Na₂O | 0-0.5 | weight-% |
| K₂O | 0-0.5 | weight-%, wherein the |
| Σ Li₂O + Na₂O + K₂O is | 0-1 | weight-%, and |
| MgO | 0-5 | weight-% |
| CaO | 0-15 | weight-% |
| SrO | 0-5 | weight-% |
| BaO | 20-48.7 | weight-% |
| TiO₂ | 0-1 | weight-% |
| ZrO₂ | 0-1 | weight-% |
| CeO₂ | 0-0.5 | weight-% |
| Fe₂O₃ | 0-0.1 | weight-% |
| WO₃ | 0-2 | weight-% |
| Bi₂O₃ | 0-28.7 | weight-% |
| MoO₃ | 0-5 | weight-% |
| ZnO | 0-3 | weight-% |
| PbO | 0-28.7 | weight-%, wherein |
| Yb₂O₃ | 0-18.7 | weight-% |
| Sm₂O₃ | 0-18.7 | weight-% |
| Dy₂O₃ | 0-18.7 | weight-% |
| FeO | 0-10 | weight-% |
| CuO | 0-10 | weight-% |

wherein the sum of Yb₂O₃, Sm₂O₃, Dy₂O₃, FeO and CuO is 0.3-29 weight-%, the ΣAl₂O₃ + B₂O₃ + BaO + PbO + Bi₂O₃ is 21-49.7 weight-%, wherein at least one of Hf, Ta, W, Re, Os, Ir, Pt, La, Pr, Nd, Eu, Gd, Tb, Ho, Er, Tm, and Lu is present in oxidic form at contents of 0-28.7 weight-%, and at least one refining agent in normal concentrations.

16. The backlight system according to claim 1, wherein said glass envelope includes one of the following compositions:

| | | |
|---|---|---|
| SiO₂ | 63-72 | weight-% |
| B₂O₃ | 15-20.2 | weight-% |
| Al₂O₃ | 0-5 | weight-% |
| Li₂O | 0-5 | weight-% |
| Na₂O | 0-8 | weight-% |
| K₂O | 0-8 | weight-%, wherein the |
| Σ Li₂O + Na₂O + K₂O is | 0.5-10 | weight-%, and |
| MgO | 0-3 | weight-% |
| CaO | 0-5 | weight-% |
| SrO | 0-3 | weight-% |
| BaO | 0-20.2 | weight-%, wherein the |
| Σ MgO + CaO + SrO + BaO is | 0-20.2 | weight-%, and |
| ZnO | 0-20.2 | weight-% |
| ZrO₂ | 0-5 | weight-% |
| TiO₂ | >0.5-10 | weight-% |
| CeO₂ | 0-0.5 | weight-% |
| MnO₂ | 0-1.0 | weight-% |
| Nd₂O₃ | 0-1.0 | weight-% |
| WO₃ | 0-2 | weight-% |
| Bi₂O₃ | 0-5 | weight-% |
| MoO₃ | 0-5 | weight-% |
| As₂O₃ | 0-1 | weight-% |
| Sb₂O₃ | 0-1 | weight-% |
| SO₄⁽²⁻⁾ | 0-2 | weight-% |
| Cl⁻ | 0-2 | weight-% |
| F⁻ | 0-2 | weight-%, wherein |
| Yb₂O₃ | 0-20.5 | weight-% |
| Sm₂O₃ | 0-20.5 | weight-% |
| Dy₂O₃ | 0-20.5 | weight-% |
| FeO | 0-10 | weight-% |
| CuO | 0-10 | weight-% |

wherein the sum of Yb₂O₃, Sm₂O₃, Dy₂O₃, FeO and CuO is 0.3-20.5 weight-%, and the Σ Fe₂O₃ + CeO₂ + TiO₂ + PbO + As₂O₃ + Sb₂O is 0.5-10 weight-%, and at least one refining agent in normal concentrations.

17. The backlight system according to claim 1, characterized in that the glass envelope comprises one of the following compositions:

| | | |
|---|---|---|
| SiO₂ | 67-74 | weight-% |
| B₂O₃ | 5-10 | weight-% |
| Al₂O₃ | 3-10 | weight-% |
| Li₂O | 0-4 | weight-% |
| Na₂O | 0-10 | weight-% |
| K₂O | 0-10 | weight-%, wherein the |
| Σ Li₂O + Na₂O + K₂O is | 0.5-10.5 | weight-% |
| MgO | 0-2 | weight-% |
| CaO | 0-3 | weight-% |
| SrO | 0-3 | weight-% |
| BaO | 0-24.1 | weight-% |
| ZnO | 0-24.1 | weight-%, wherein the |
| Σ MgO + CaO + SrO + BaO + ZnO | 0-24.1 | weight-%, |
| is | | |
| ZrO₂ | 0-3 | weight-% |
| CeO₂ | 0-1 | weight-% |

and that at least one of TiO₂, Bi₂O₃, and MoO₃ are contained in an
amount, always independent of each other, of 0-10 weight-%, wherein
Σ TiO₂ + Bi₂O₃ + MoO₃ are 0.1-10 weight-%, and

| | | |
|---|---|---|
| Yb₂O₃ | 0-24.4 | weight-% |
| Sm₂O₃ | 0-24.4 | weight-% |
| Dy₂O₃ | 0-24.4 | weight-% |
| FeO | 0-10 | weight-% |
| CuO | 0-10 | weight-% |

wherein the sum of Yb₂O₃, Sm₂O₃, Dy₂O₃, FeO and CuO is 0.3-24.4
weight-%, and at least one refining agent in normal concentrations.

18. The backlight system according to claim 1, wherein said glass envelope, which is configured for being used in an external electrode fluorescent lamp, includes one of the following compositions:

| | | |
|---|---|---|
| SiO₂ | 60-85 | weight-% |
| B₂O₃ | 0-10 | weight-% |
| Al₂O₃ | 0-10 | weight-% |
| Li₂O | 0-10 | weight-% |
| Na₂O | 0-20 | weight-% |
| K₂O | 0-20 | weight-%, wherein the |
| Σ Li₂O + Na₂O + K₂O is | 5-25 | weight-% and |
| MgO | 0-8 | weight-% |
| CaO | 0-20 | weight-% |
| SrO | 0-5 | weight-% |
| BaO | 0-30 | weight-%, wherein |
| Σ MgO + CaO + SrO + BaO is | 3-30 | weight-%, and |
| ZnO | 0-20 | weight-%, |
| ZrO₂ | 0-5 | weight-% |
| TiO₂ | 0-10 | weight-% |
| Fe₂O₃ | 0-5 | weight-% |
| CeO₂ | 0-5 | weight-% |
| MnO₂ | 0-5 | weight-% |
| Nd₂O₃ | 0-1.0 | weight-% |
| WO₃ | 0-2 | weight-% |
| Bi₂O₃ | 0-5 | weight-% |
| MoO₃ | 0-5 | weight-% |
| PbO | 0-5 | weight-% |
| As₂O₃ | 0-1 | weight-% |
| Sb₂O₃ | 0-1 | weight-% |

wherein the Σ Fe₂O₃ + CeO₂ + TiO₂ + PbO + As₂O₃ + Sb₂O₃ is
0-10 weight-% and wherein the Σ PdO + PtO₃ + PtO₂ + PtO + RhO₂ +
Rh₂O₃ + IrO₂ + Ir₂O₃ is 0.1 weight-%, and

| | | |
|---|---|---|
| SO₄²⁻ | 0-2 | weight-% |
| Cl⁻ | 0-2 | weight-% |
| F⁻ | 0-2 | weight-% |
| Yb₂O₃ | 0-31.9 | weight-% |
| Sm₂O₃ | 0-31.9 | weight-% |
| Dy₂O₃ | 0-31.9 | weight-% |
| FeO | 0-10 | weight-% |
| CuO | 0-10 | weight-% |

wherein the sum of Yb₂O₃, Sm₂O₃, Dy₂O₃, FeO and CuO is 0.3-31.9
weight-%, and at least one refining agent in normal concentrations.

19. The backlight system according to claim 1, wherein said at least one light source is a fluorescent lamp which is at least one of an external electrode fluorescent lamp, a gas discharge lamp, and an illumination for at least one of liquid crystal displays, computer monitors, and telephone displays.

20. The backlight system according to claim 1, wherein said glass envelope has one of a tubular body and a tubular-like body.

21. The backlight system according to claim 20, wherein at least one of (a) a diameter of one of said tubular body and said tubular-like body is <0.8 cm and (b) a wall thickness of one of said tubular body and said tubular-like body is <1 mm.

22. The backlight system according to claim 1, wherein said glass envelope of said at least one light source includes a flat glass with a thickness of <1 cm.

23. A backlight system for background illumination of one of a display and a screen, said backlight system comprising:
at least one light source including a glass envelope having a glass composition;
a light distributing unit which is a light guide plate and which includes a synthetic material, at least one of
(a) said glass composition of said glass envelope being doped with at least one doping oxide which absorbs IR-radiation,
(b) said glass envelope including a first coating which absorbs said IR-radiation and which is at least one of an outside coating and an inside coating, and
(c) the backlight system including a second coating and a plurality of components other than said glass envelope, said second coating being on said plurality of components and absorbing said IR-radiation.

24. A backlight glass envelope, comprising:
at least one of (a) a glass composition of the backlight glass envelope being doped with at least one doping oxide which absorbs IR-radiation, and (b) the backlight glass envelope including a coating which absorbs said IR-radiation and which is an outside coating.

25. The backlight glass envelope according to claim 24, wherein said at least one doping oxide is selected from at least one of ytterbium-oxide, dysprosium-oxide, samarium-oxide, iron(II)oxide, copper(II)oxide, and at least one compound thereof.

26. The backlight glass envelope according to claim 24, wherein said coating is also IR-reflecting.

27. The backlight glass envelope according to claim 24, wherein said coating is selected from one of (a) SiO₂ and TiO₂ layers, and (b) SiO₂ and Ta₂O₅ layers.

28. The backlight glass envelope according to claim 24, wherein the backlight glass envelope includes one of the following compositions:

| | | |
|---|---|---|
| SiO₂ | 55-85 | weight-% |
| B₂O₃ | 0-35 | weight-% |
| Al₂O₃ | 0-20 | weight-% |
| Li₂O | 0-10 | weight-% |
| Na₂O | 0-20 | weight-% |
| K₂O | 0-20 | weight-%, wherein the |
| Σ Li₂O + Na₂O + K₂O is | 0-25 | weight-%, and |
| MgO | 0-8 | weight-% |
| CaO | 0-20 | weight-% |
| SrO | 0-5 | weight-% |
| BaO | 0-45 | weight-%, wherein the |
| Σ MgO + CaO + SrO + BaO | 0-45 | weight-%, and |
| TiO₂ | 0-10 | weight-% |
| ZrO₂ | 0-3 | Weight-% |
| CeO₂ | 0-3 | weight-% |
| WO₃ | 0-3 | weight-% |
| Bi₂O₃ | 0-3 | weight-% |
| MoO₃ | 0-3 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

wherein the sum of Yb₂O₃, Sm₂O₃, Dy₂O₃, FeO, and CuO is 0.3-45 weight-%, and at least one refining agent, in normal concentrations, including at least one of chloride, sulfates, As₂O₃, and Sb₂O₃.

29. A method comprising the steps of:
utilizing, and thereby absorbing IR-radiation in a backlight system, at least one of
(a) a glass envelope which is at least one of (i) doped with at least one doping oxide which absorbs said IR-radiation, and (ii) includes a first coating which absorbs said IR-radiation and which is an outside coating, and
(b) a second coating on a plurality of components, other than said glass envelope, of a backlight system, said second coating absorbing said IR-radiation.

30. The method according to claim 29, wherein said at least one doping oxide is selected from at least one of ytterbium-oxide, dysprosium-oxide, samarium-oxide, iron(II)oxide, copper(II)oxide, and at least one compound thereof.

31. The method according to claim 29, wherein said plurality of components having thereon said second coating absorbing said IR-radiation includes at least one of a light distributing unit, a diffuser plate, one of a support plate and a support disk, one of a cover plate and a protective plate, at least partial surfaces or sections of said backlight system, and components thereof.

32. The method according to claim 29, wherein at least one of said first coating and said second coating is also IR-reflecting.

33. The method according to claim 29, wherein at least one of said first coating and said second coating is selected from one or a combination of the following:
SiO₂ and TiO₂ layers,
SiO₂ and Ta₂O₅ layers,
S₂O₂ and Nb₂O₂ layers,
SiO₂ and Y₂O₃ layers,
SiO₂ and ZrO₂ layers,
Transparent conductive layers,
In₂O₃ layers,
SnO₂ layers,
ZnO layers,
Transparent conductive layers, doped with Sn, F,
In₂O₃ layers doped with Sn, F,
SnO₂ layers doped with Sn, F,
ZnO layers doped with Sn, F,
Silver layers, and
Silver-based layer systems.

34. The method according to claim 29, wherein said backlight system includes a light source which includes said glass envelope, said light source being a discharge lamp.

35. The method according to claim 34, wherein said discharge lamp includes a discharge chamber which is filled with a plurality of discharge substances including at least one of neon, argon, xenon, rare earth ions, and mercury.

36. The method according to claim 34, wherein said glass envelope of said discharge lamp includes an inside and a fluorescent layer applied on said inside.

37. The method according to claim 29, wherein said glass envelope includes one of the glass compositions:

| | | |
|---|---|---|
| SiO₂ | 55-85 | weight-% |
| B₂O₃ | 0-35 | weight-% |
| Al₂O₃ | 0-20 | weight-% |
| Li₂O | 0-10 | weight-% |
| Na₂O | 0-20 | weight-% |
| K₂O | 0-20 | weight-%, wherein the |
| Σ Li₂O + Na₂O + K₂O is | 0-25 | weight-%, and |
| MgO | 0-8 | weight-% |
| CaO | 0-20 | weight-% |
| SrO | 0-5 | weight-% |
| BaO | 0-45 | weight-%, wherein the |
| Σ MgO + CaO + SrO + BaO | 0-45 | weight-%, and |
| TiO₂ | 0-10 | weight-% |
| ZrO₂ | 0-3 | weight-% |
| CeO₂ | 0-3 | weight-% |
| WO₃ | 0-3 | weight-% |
| Bi₂O₃ | 0-3 | weight-% |
| MoO₃ | 0-3 | weight-% |
| Yb₂O₃ | 0-40 | weight-% |
| Sm₂O₃ | 0-40 | weight-% |
| Dy₂O₃ | 0-40 | weight-% |
| FeO | 0-10 | weight-% |
| CuO | 0-10 | weight-% |

wherein the sum of Yb₂O₃, Sm₂O₃, Dy₂O₃, FeO, and CuO is 0.3-45 weight-%, and at least one refining agent, in normal concentrations, including at least one of chloride, sulfates, As₂O₃, and Sb₂O₃.

38. A method comprising the steps of:
providing a backlight glass envelope including at least one of
(a) a glass composition of said backlight glass envelope being doped with at least one doping oxide which absorbs IR-radiation, and
(b) said backlight glass envelope including a coating which absorbs said IR-radiation and which is an outside coating; and
producing said coating on said backlight glass envelope by carrying out coating said coating in a microwave reactor using a microwave plasma chemical vapor deposition method.

39. A method of using a backlight system for background illumination of one of a display and a screen, said method comprising the steps of:
providing that the backlight system includes at least one light source including a glass envelope having a glass composition, at least one of
(a) said glass composition of said glass envelope being doped with at least one doping oxide which absorbs IR-radiation,
(b) said glass envelope including a first coating which absorbs said IR-radiation and which is at least one of an outside coating and an inside coating, and
(c) the backlight system including a second coating and a plurality of components other than said glass envelope, said second coating being on said plurality of components and absorbing said IR-radiation; and
using the backlight system in an electronic device, a liquid crystal display, a computer monitor, and a telephone display.
